(19) United States
(12) Patent Application Publication
(10) Pub. No.: US 2018/0295079 A1
(43) Pub. Date: Oct. 11, 2018

(54) METHODS AND APPARATUS FOR ASYNCHRONOUS DIGITAL MESSAGING

(71) Applicant: Anthony Longo, Boston, MA (US)

(72) Inventor: Anthony Longo, Boston, MA (US)

(21) Appl. No.: 15/945,130

(22) Filed: Apr. 4, 2018

Related U.S. Application Data
(60) Provisional application No. 62/481,390, filed on Apr. 4, 2017.
(60) Provisional application No. 62/521,639, filed on Jun. 19, 2017.

(51) Int. Cl. H04L 12/58

(52) U.S. Cl. CPC H04L 51/066; H04L 51/24; H04L 51/10; H04L 51/046

(57) ABSTRACT

Methods and apparatus for asynchronous digital messaging using a multi-dimensional messaging platform are described. The messaging platform automatically transforms received content into different data formats consumable by message recipients. An application designed for use with the messaging platform provides a simple one-touch gesture interface configured to invoke a video messaging feature used to annotate images or documents sent via the messaging platform or for providing messaging content in a proper format for another application.

### RELATED APPLICATIONS

This Application claims the benefit under 35 USC 119(e) of U.S. Provisional Patent Application Ser. No. 62/481,390, filed Apr. 4, 2017, entitled “METHODS AND APPARATUS FOR ASYNCHRONOUS DIGITAL MESSAGING” and U.S. Provisional Patent Application Ser. No. 62/521,639, filed Jun. 19, 2017, entitled “METHODS AND APPARATUS FOR ASYNCHRONOUS DIGITAL MESSAGING,” the entire contents of each of which is incorporated by reference herein.

### BACKGROUND

Effective communication between business professionals has become more difficult in situations where collaborators are frequently “on-the-go” and rely primarily on receiving communications on mobile devices. For example, sales and marketing professionals are often on the road to perform their job functions, and as such they communicate with colleagues and clients on mobile devices, such as their smartphone. Synchronous or “real-time” communications tools such as phone calls, video chat, and live conferencing applications, which enable participants to engage in live conversations, are often not the preferred communications format for such professionals due to the need for the recipient of the communication to be available for the synchronous communication session when requested. Asynchronous communication tools enable recipients to respond to received messages at their convenience. Electronic mail (email) has become the most widely adopted asynchronous communication tool among business professionals, though other tools such as text messaging and voicemail are also used.

### SUMMARY

According to one aspect of the technology described herein, some embodiments are directed to a messaging platform configured to asynchronously provide messaging content in a plurality of content formats. Messaging content received from a user by the platform may be automatically translated into different formats consumable by other users or applications (“apps”). In some embodiments, the messaging platform is also configured to enrich the messaging content using artificial intelligence techniques to provide an enriched viewing experience for a recipient and/or device (display), computing machine or “bot” of the message.

According to another aspect, an application configured to use the messaging platform provides one-touch gesture control that enables a user to efficiently select and send images or other digital attachments together with a video message explaining the content of the attachment(s). In some embodiments, the image is a static or live recorded screen capture of a webpage described by the user in the associated video message. In other embodiments, the attachment is a locally-stored or cloud-based file.

According to another aspect, an application configured to use the messaging platform is configured to have a multi-dimensional user interface that enables the user to efficiently select a message recipient. In some embodiments, the message recipient may be another user using the platform, another user not using the platform, an electronic device not associated with a user (e.g., a television or refrigerator), or an application.

According to another aspect, a messaging platform is provided that enables efficient messaging communication on electronic devices without a keyboard interface. The messaging platform automatically reformats messages from a sender to an appropriate format or formats to be displayed by the message recipient.

According to another aspect, one-touch integration with existing third-party apps is provided. When an app is selected as the message recipient, a user may use a simple one-touch (e.g., tap and hold) gesture to record a video or audio message that is automatically translated into the appropriate format for the app. The translated message is then sent to the app where it is displayed as if the message was composed natively within the app.

According to another aspect, a messaging platform is provided that enables transition from asynchronous communication between users on the platform to a synchronous communication session initiated via the platform. Users actively engaged in bidirectional asynchronous messaging using the platform are alerted to the option of starting a synchronous communication session (e.g., phone call, live video communication session).

According to another aspect, a technique for improving a speech to text transcription process is provided. Video messages of a user speaking are recorded and used to generate a user-specific model of visual speech. The model may be used to improve the accuracy of a third party speech to text transcription process.

According to another aspect, a technique for providing time-based information about a sequence of video messages in a conversation is provided. The time-based information may help users understand information about the conversation including information about the conversation participants and the content of the messages in a conversation.

According to another aspect, a computer system configured to provide asynchronous messaging is provided. The computer system comprises one or more network-connected computer processors programmed to implement a messaging platform. The messaging platform is configured to receive input message data from a first electronic device, process, using a multi-format generation engine, the input message data to generate reformatted data in one or more alternative formats, store the input message data and the reformatted data in one or more datastores, receive a request from a second electronic device for message information related to the input message data, select a format to provide the message information to the second electronic device, access, based on the selected format, the message information as the stored input message data or the stored reformatted data, and asynchronously provide the message information to the second electronic device.

According to another aspect, a computer-implemented method of providing asynchronous messaging between electronic devices is provided. The method comprises receiving input message data from a first electronic device, processing, by at least one computer processor, the input message data to generate reformatted data in one or more alternative formats, storing the input message data and the reformatted data in one or more datastores, receiving a request from a second electronic device for message information related to the input message data, selecting a format to provide the message information to the second electronic device, accessing, based on the selected format, the message information as the stored input message data or the stored reformatted data, and asynchronously providing the message information to the second electronic device.

According to another aspect, a non-transitory computer readable medium encoded with a plurality of instructions that, when executed by at least one computer processor, performs a method is provided. The method comprises receiving input message data from a first electronic device, processing the input message data to generate reformatted data in one or more alternative formats, storing the input message data and the reformatted data in one or more datastores, receiving a request from a second electronic device for message information related to the input message data, selecting a format to provide the message information to the second electronic device, accessing, based on the selected format, the message information as the stored input message data or the stored reformatted data, and asynchronously providing the message information to the second electronic device.

It should be appreciated that all combinations of the foregoing concepts and additional concepts discussed in greater detail below (provided such concepts are not mutually inconsistent) are contemplated as being part of the inventive subject matter disclosed herein.

### BRIEF DESCRIPTION OF THE DRAWINGS

Various non-limiting embodiments of the technology will be described with reference to the following figures. It should be appreciated that the figures are not necessarily drawn to scale.

FIG. 1 is a block diagram of a computer-implemented system on which some embodiments may be deployed;

FIG. 2 is an example implementation of a system designed in accordance with some embodiments;

FIG. 3 is a flowchart of a process for providing enhanced communication in accordance with some embodiments;

FIG. 4 is a flowchart of a process for using video to annotate a website screen capture in accordance with some embodiments;

FIG. 5 is a flowchart of a process for sending a file annotated with a video message in accordance with some embodiments;

FIGS. 6A-6G illustrate portions of a user interface for annotating an image with a video message in accordance with some embodiments;

FIGS. 7A and 7B illustrate portions of a user interface for initiating a one-touch communication process in accordance with some embodiments;

FIG. 8 illustrates a portion of a user interface for canceling a communication in accordance with some embodiments;

FIGS. 9A and 9B illustrate portions of a user interface for monitoring a recipient's actions in accordance with some embodiments;

FIG. 10 illustrates a portion of a user interface for displaying a transcription of a video message in accordance with some embodiments;

FIGS. 11A and 11B illustrate portions of a user interface for providing notifications to a user of an electronic device in accordance with some embodiments;

FIGS. 12A-12C illustrate portions of a user interface for integrating a one-touch communication process with a mobile application in accordance with some embodiments;

FIG. 13 is a flowchart of a process for initiating a synchronous communication session between users engaged in asynchronous communication;

FIG. 14 is a flowchart of a process for user-specific video-based enhancement of speech to text translation in accordance with some embodiments;

FIG. 15 is a flowchart of a process for processing audio during recording of a video message in accordance with some embodiments; and

FIG. 16 illustrates a portion of a user interface for providing a visual indication of time-based information for a video message conversation in accordance with some embodiments.

### DETAILED DESCRIPTION

The inventor has recognized and appreciated that conventional asynchronous messaging tools, such as electronic mail (e-mail), are cumbersome for users of mobile devices to use and often do not provide a rich content experience. For example, most e-mail applications are designed to produce messages based primarily on received keyboard input. Whereas typing on a keyboard of a laptop or desktop computer is an efficient way to construct a message for an e-mail program, constructing messages for e-mail applications on mobile devices with limited keyboard options is tedious. Indeed, many business professionals report that their ability to communicate via e-mail after leaving their desk is substantially reduced. To this end, some embodiments are directed to techniques for providing a contextual messaging platform that enables users to engage in efficient asynchronous communication on electronic devices, such as smartphones.

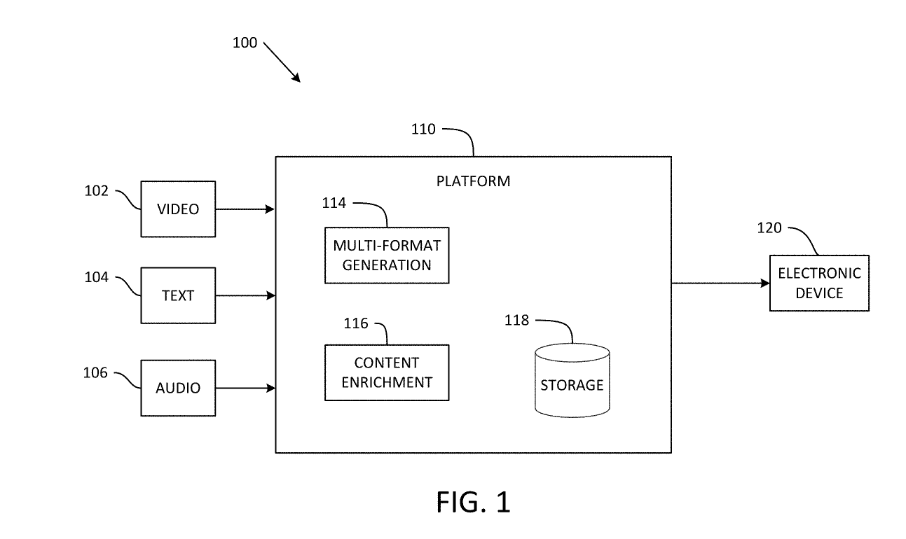

FIG. 1 is an illustrative block diagram of a system 100 for providing asynchronous communication in accordance with some embodiments. Platform 110, which may be implemented by one or more network-connected (e.g., cloud-based) computers, is configured to receive data input from a plurality of electronic devices. For example, as shown, platform 110 is configured to receive video data 102, text data 104 and audio data 106 from an electronic device such as a smartphone. Platform 110 may be implemented by one or more computer processors programmed to process the received input data. Upon receiving input data, platform 110 may be configured to process the data using multi-format generation engine 114 to generate data in one or more alternative formats other than the format in which the data was received. For example, multi-format generation engine 114 may be configured to perform one or more of speech to text conversion, text to speech conversion, text to speech to video conversion, and conversion to a format consumable by a particular application. The received data and/or one or more of the alternative formatted data may be enriched by content enrichment engine 116. Examples of data enrichment are described in more detail below.

Both the received data and the converted data may be stored in one or more data stores 118 prior to being provided from the messaging platform to a message recipient, an example of which is electronic device 120. In some embodiments, the format or combination of formats of data provided to the message recipient is selected based, at least in part, on one or more of, an application on the electronic device configured to present the data, the type of electronic device and/or the settings of electronic device to which the data is to be provided, and one or more user preferences. The user preferences may be determined based on settings specified by a user of electronic device, determined based on usage history, or determined in any other suitable way. In some embodiments, the format or combination of formats of data provided to the message recipient is selected to provide an optimized experience on the electronic device 120. Determining the optimized experience may be based, at least in part, on a best human-to-device experience or machine-to-machine efficiency, for example.

Platform 110 may communicate asynchronously with electronic device 120 to inform a user of the device that a message is available for viewing. In some embodiments, the communication may be a push notification that alerts the user to the presence of the message. The push notification may include text information to enable the user to prioritize the message. For example, the push notification may include one or more of keyword information, summary information, sender information, and emotion information associated with the content of the message. In some embodiments, the push notification may be enriched with information by changing the format of the notification to signify a priority of the message. For example, the color, size, and/or placement of the notification on the screen may be changed based on a priority determined for the message.

Platform 110 may be configured to communicate with any of a plurality of electronic devices including, but not limited to, devices with a display such as smartphones, tablet computers, desktop computers, laptop computers, electronic home appliances such as televisions and refrigerators, and portable or in-car navigation systems, devices with a limited display such as a smartwatch or smart glasses, or devices with no display such as wireless ear pods or a voice activated intelligent automated assistant service (e.g., Amazon Alexa, Google Home).

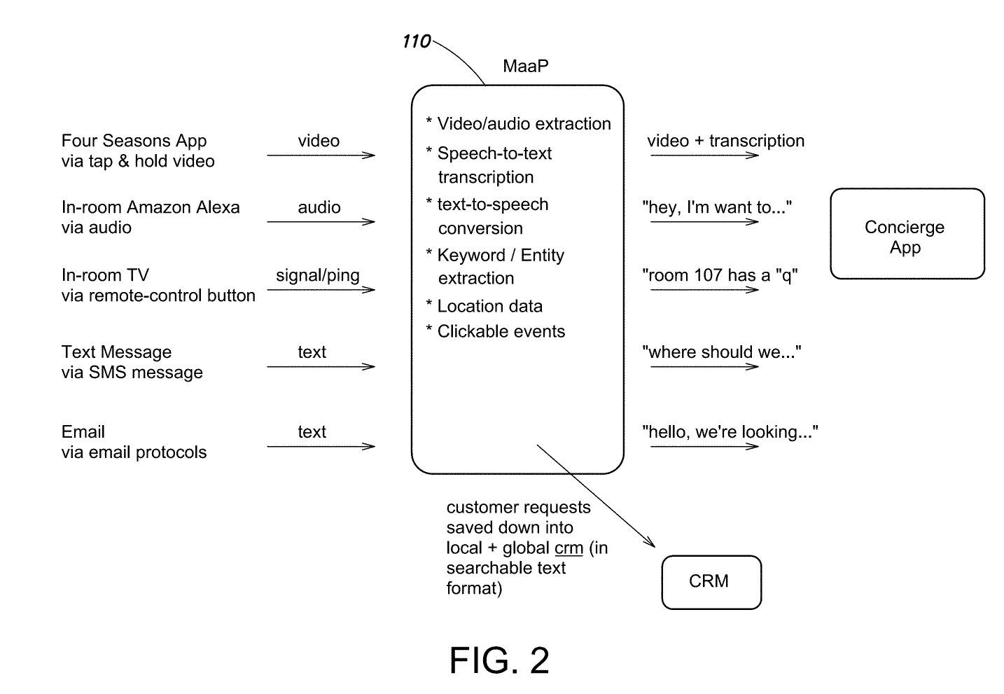

FIG. 2 schematically illustrates an example of an implementation of platform 110 that enables hotel customers to interact with a concierge app for the hotel using various input devices. As shown, input devices include a smartphone app that includes one-touch functionality to transmit video to the platform, an in-room intelligent automated assistant service (Amazon Alexa) configured to transmit audio to the platform, a remote-controlled in-room TV configured to send data signals to the platform, a text messaging app configured to send text to the platform, and an email application configured to send text to the platform. The hotel customer may interact with one or more of these input devices to make requests of the hotel concierge app. As shown, platform 110 processes inputs received from the input devices and provides a suitable output to the concierge app based on the request. Customer requests entered via an input device may also be stored in a local or cloud-based customer relationship management (CRM) system.

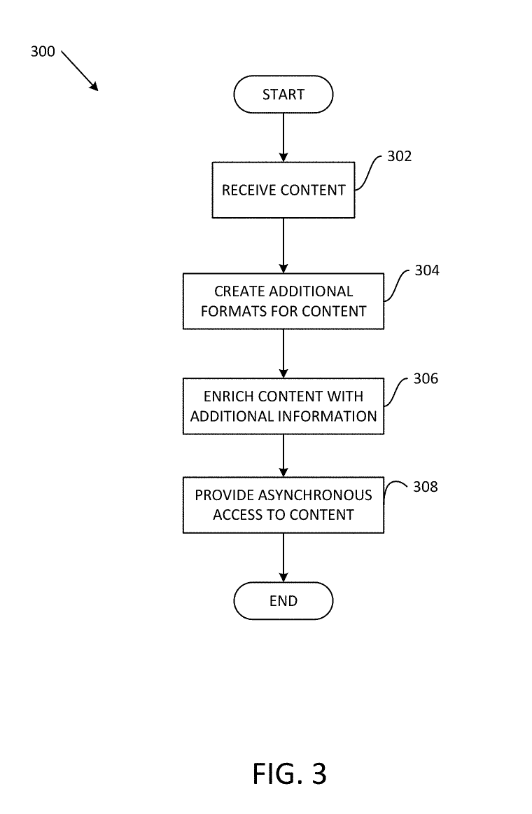

FIG. 3 illustrates a process 300 for asynchronous communication in accordance with some embodiments. In act 302, content, examples of which include audio data, text data and video data, is received one or more computer processors programmed to implement a data processing platform. The process then proceeds to act 304 where one or more additional formats are created for the received content. For example, audio may be extracted from a video and saved as audio data, audio data may be converted to text, text may be converted to speech, or any of text, audio, or video may be reformatted in a format consumable by an application. The process then proceeds to act 306, where the original or reformatted content may be enriched with additional information. Examples of enrichment include but are not limited to, natural language processing, keyword/entity extraction, association of device metadata such as location information, time information, motion information, distance information, weather information, or venue information, association with user-selectable events (e.g., hyperlinks, user interface elements), emotion analysis, behavioral analytics, or any combination thereof. The original and reformatted data and associated enrichments may be stored in one or more datastores prior to being provided to an electronic device. The process then proceeds to act 308 where asynchronous access to the stored content is provided to an electronic device. In some implementations a push notification may be sent to the electronic device associated with or selected as the message recipient, and in response to receiving a request from the electronic device to provide the content, the content may be provided in a format that provides a desired user experience for a user of the device.

In some embodiments, when a user requests to provide the content, it may first be determined whether the electronic device is in a non-audio (e.g., silent or vibrate) mode. If it is determined that the electronic device is in a non-audio mode, it may be assumed that the user does not want audio output, and at least a portion of a transcription of the video message may be displayed on the electronic device by default rather than playing back the video message with audio. If the user turns the audio of the electronic device on, the transcription may be hidden from view and the video message may be output with audio.

Some embodiments are directed to one or more applications or “apps” configured to interact with the messaging platform described above. The inventor has recognized and appreciated that two actions that are used frequently when sending emails: (1) sharing a website address (Uniform Resource Locator—URL) and (2) sharing a digital attachment (e.g., an image or document) often require, in addition to the URL or attachment, a written explanation for what is attached or behind the URL. Some embodiments are directed to novel techniques for sending a URL or a digital attachment using a one-touch interface to annotate the URL or attachment being sent using a video message from the sender. Such embodiments improve efficiency and effectiveness of communication for both the sender (e.g., message composition) and receiver (e.g., message comprehension).

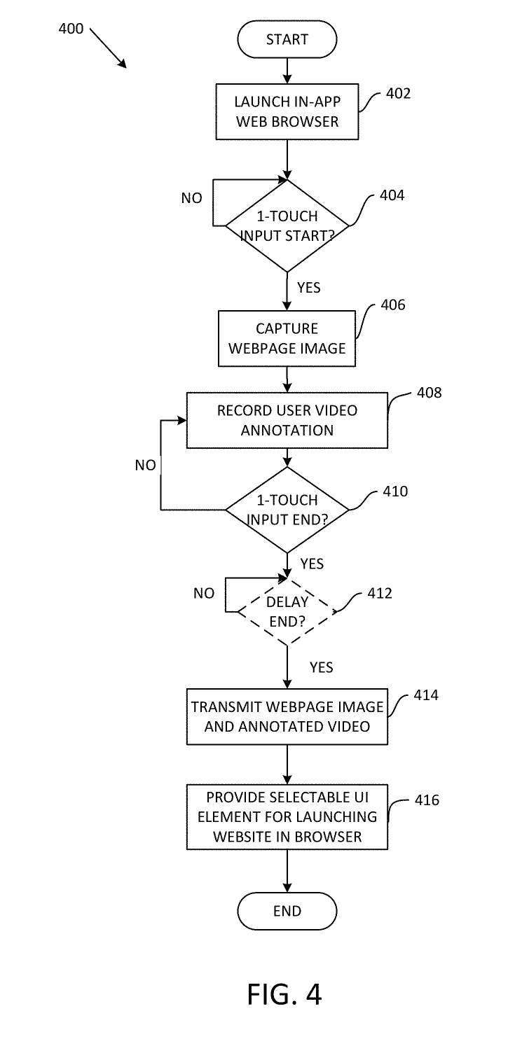

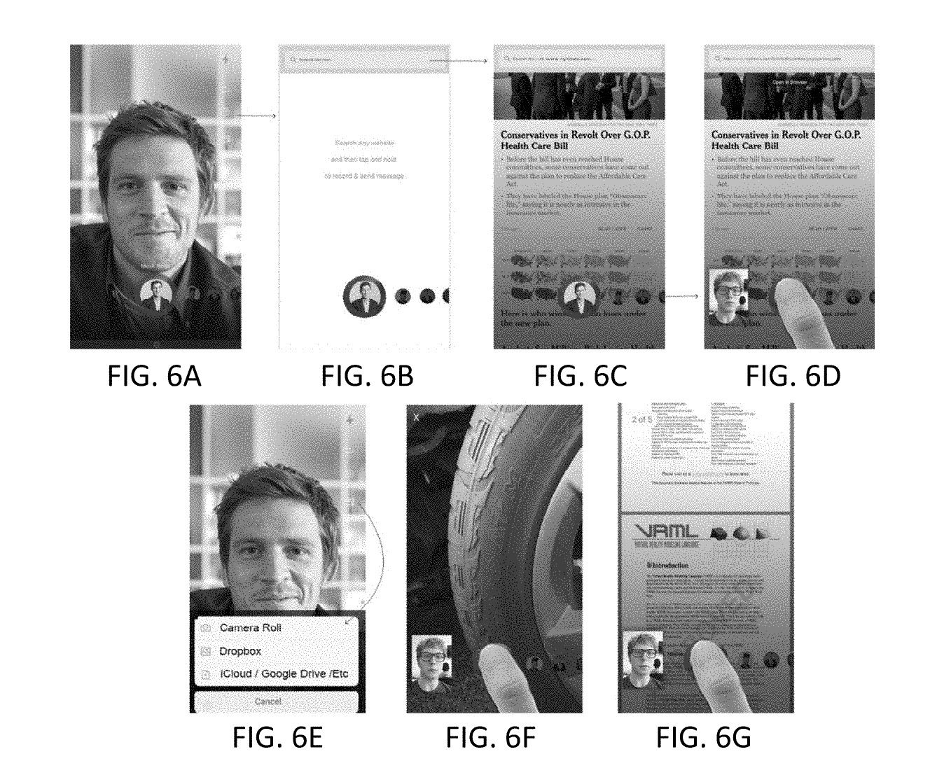

FIG. 4 illustrates a process 400 for sharing a message with a URL between two electronic devices configured to use a platform for asynchronous communication as described herein. For example, both electronic devices may have an app installed thereon that interacts with the platform to transfer asynchronous messages between users of the devices. FIGS. 6A-6D illustrate screenshots of a user interface of an example app installed on an electronic device (e.g., a smartphone) that illustrate functionality described in the process 400. For example, FIG. 6A illustrates a portion of a user interface in which a user selects the recipient of a message.

In act 402 of process 400, a user of a first (sender) electronic device, launches an in-app web browser that enables the user to navigate to a web page. FIG. 6B illustrates a portion of the user interface in which the user is instructed to navigate to a website and provide a one-touch gesture to record and send a message. FIG. 6C illustrates a portion of the user interface in which the user has navigated to the a web page, which is shown in the background portion of the user interface, while the message recipient is shown in the foreground portion of the user interface.

The process then proceeds to act 404 where it is determined whether the user has interacted with the device using a one-touch gesture. A non-limiting example of a one-touch gesture is a tap and hold gesture, where the user places and holds their finger on a touch sensitive screen of the device. If it is determined in act 404 that the user has not started a one-touch gesture, the process continues to monitor for such a gesture. FIG. 6D illustrates a portion of the user interface when the user interacts with the device using a one-touch gesture.

When a one-touch gesture is detected on the first device, the process proceeds to act 406, where a screen capture of the web page displayed on the first device is performed. The process then proceeds to act 408 where a video of the user is recorded and associated with the captured webpage image. For example, use of the one-touch gesture may trigger activation of a user-facing camera on a smartphone or other computing device to begin recording video of the user. FIG. 6D illustrates one implementation of the user interface that displays, in the lower right corner of the user interface, the user video being recorded. The process then proceeds to act 410 where it is determined whether the user has completed the one-touch gesture (e.g., by removing the finger from the display).

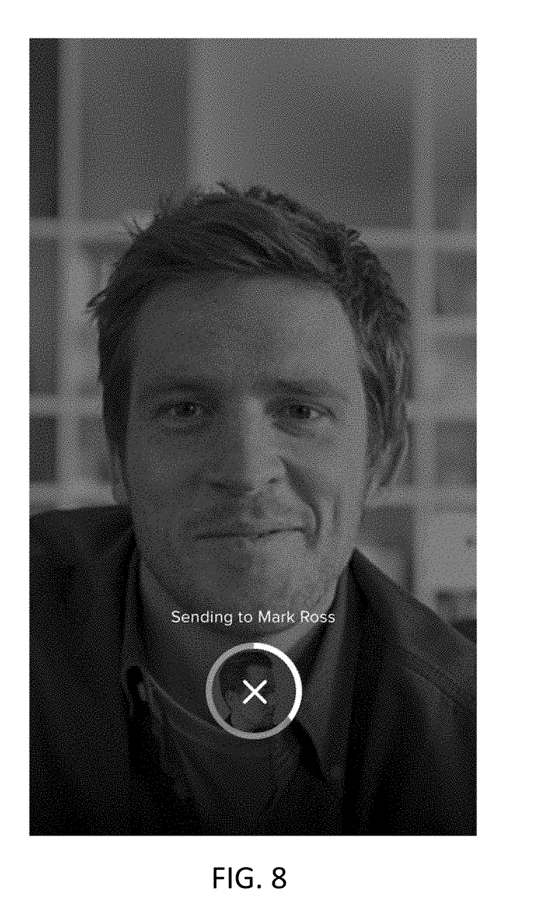

When it is determined that the one-touch gesture has been completed the process proceeds to act 412 where optionally it is determined whether a delay period has ended. Rather than sending the video message and captured webpage image immediately to the recipient when the one-touch gesture is completed, some embodiments include a delay period that enables the sender to cancel transmission of the message within the delay period. FIG. 8 illustrates a portion of a user interface for providing functionality to cancel transmission of a message during the delay period. When it has been determined in act 412 that the delay period has ended, the process proceeds to act 414, where the captured webpage image and the annotated video message are transmitted to the platform for processing. The process then proceeds to act 416 where the platform may be configured to add one or more enrichments to the transmitted message. For example, a selectable UI element may be displayed on the user interface of the second (recipient) electronic device to enable the user of the second device to launch the website corresponding to the captured image in a native browser of the device.

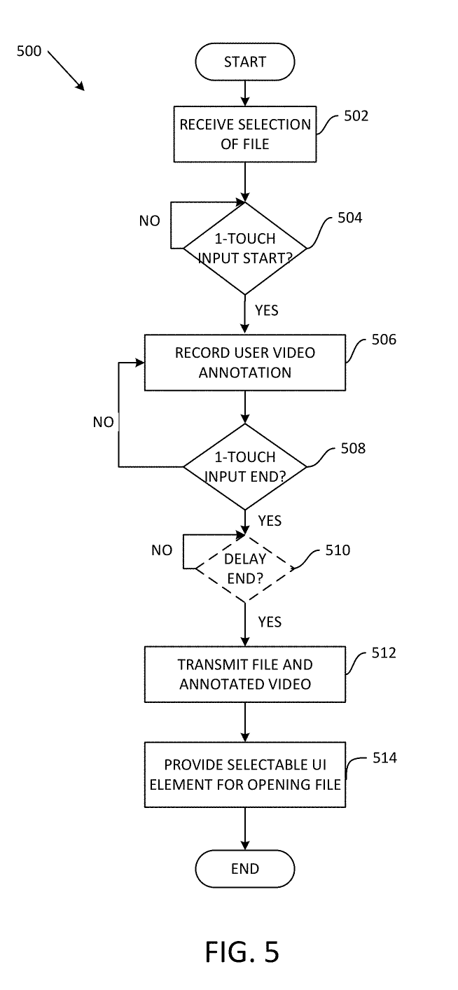

FIG. 5 illustrates a process 500 for sending a digital attachment in accordance with some embodiments. FIGS. 6E-6G illustrate screenshots of a user interface of an example app installed on an electronic device (e.g., a smartphone) that illustrate functionality described in the process 500. In act 502 of process 500, a selection of a digital attachment (e.g., a file) is received by a first (sender) electronic device. FIG. 6E illustrates a portion of a user interface in which a user selects a digital image as an attachment. Digital attachments may be selected from storage on a local device (e.g., an image stored on a smartphone) or from network-connected storage (e.g., an image stored in cloud-based storage). After a digital attachment has been selected, the process proceeds to act 504 where it is determined whether a user has started a one-touch gesture. When a one-touch gesture is detected, the process proceeds to act 506, where a user video is recorded to enable the user to provide an annotation for the digital attachment. The process then proceeds to act 510, where it is determined whether the user has completed the one-touch gesture (e.g., by removing a finger from the display).

When it is determined that the one-touch gesture has been completed the process proceeds to act 512 where optionally it is determined whether a delay period has ended. When it has been determined in act 412 that the delay period has ended, the process proceeds to act 514, where the digital attachment and the annotated video message are transmitted to the platform for processing. The process then proceeds to act 516 where the platform may be configured to add one or more enrichments to the transmitted message. For example, a selectable UI element may be displayed on the user interface of the second (recipient) electronic device to enable the user of the second device to open the digital attachment on the second device.

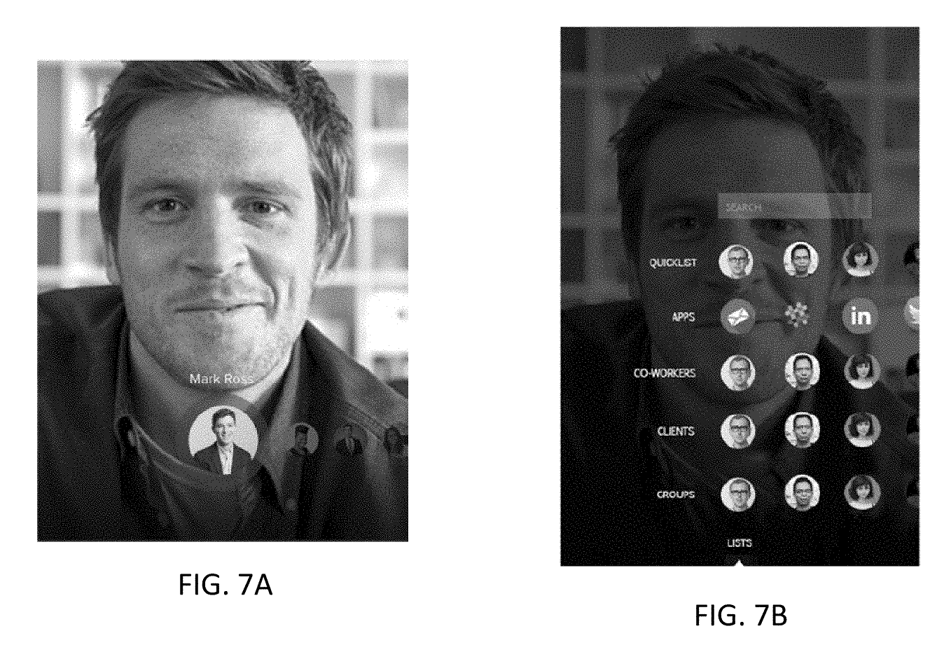

Interacting with a user interface of a mobile device is sometimes challenging due to the limited screen real estate of the mobile device. Some embodiments are directed to configuring the content displayed on the screen (and what is hidden) at particular points in time to enhance the user experience. To this end, a user interface of an app may be configured to provide a smart “carousel” interface that enables a user to quickly select a recipient of a message. FIGS. 7A and 7B show portions of an illustrative carousel interface for an app designed in accordance with some embodiments.

In response to launching the app, the user interface may be configured to display a “selfie” camera view in which the camera facing the user is activated. The user interface may then display a number (e.g., top ten) of profile thumbnails for users whom the user is most likely to interact with as shown in FIG. 7B. The profile thumbnails may include a profile thumbnail for the user of the device enabling the user to send a message to themselves. For example, used in combination with the webpage annotation example described in connection with process 400, a user may select their own profile as the message recipient and send a video annotated webpage message to themselves describing something about the webpage for later reference. The user may provide a horizontal (right-left) “swipe” gesture to cycle through the profile thumbnails to select a message recipient. In some embodiments, a determination of which profiles to show in the horizontal carousel interface may be made based, at least in part, a number of communications with the users over long or short time period, recent events, calendar information, local device settings, or any another metric. If the app is launched in response to receiving a notification from the messaging platform indicating that a message is ready to be viewed by the user of the device, the sender of the message may be automatically be displayed in focused view at the center of the carousel interface.

In some embodiments, in addition to providing for activation in one direction (e.g., the left-right direction) the carousel interface may be configured to also be activated in a second direction orthogonal to the first direction (e.g., up-down) to provide additional options for selecting a message recipient. In accordance with some embodiments, a message recipient may be another user having a device configured to use the app, another user having a device on which the app is not installed, and a “connected app” that can receive and display a reformatted version of the message. FIG. 7B shows that the carousel interface may provide the ability for the user to swipe vertically (up-down) to activate more message recipient options to utilize the vertical real estate on the screen. As shown, the recipient options may be grouped into horizontal rows of types of message recipient types. For example, one row may correspond to recently contacted entities, another row may correspond to users in a particular group, and another row may correspond to a list of “connected apps” with which the messaging platform has been integrated. Examples of connected apps including, but are not limited to, email apps, text messaging apps, social media apps (e.g., Facebook, Twitter, LinkedIn), collaboration apps (e.g., Slack), and business process apps (e.g., Salesforce). Other examples of groups of users include, but are not limited to, co-workers, clients, prospects, family members, and friends.

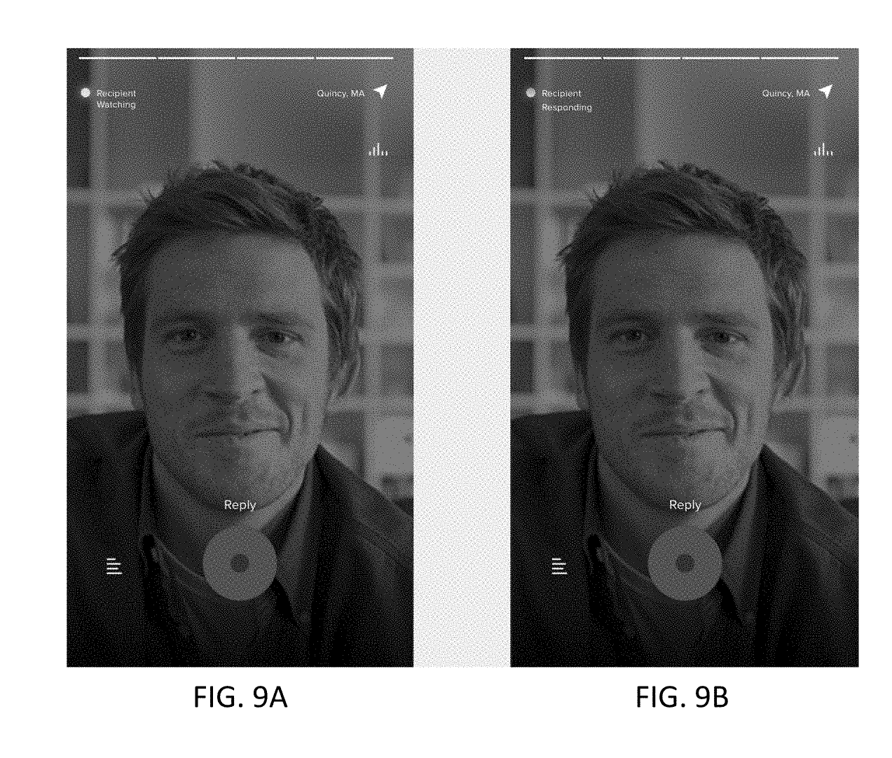

FIGS. 9A and 9B illustrate portions of a user interface that includes indicators for informing a sender of a message about the status of a message recipient in accordance with some embodiments. For example, the user interface in FIG. 9A includes an indicator showing that the recipient is currently watching the message, and the user interface in FIG. 9B includes an indicator showing that the recipient is currently responding to the message. Providing feedback to the sender about the recipient's status allows the sender to better understand how the recipient is interacting with the message and provides for an opportunity for the sender and the recipient to initiate a synchronous communication session, if desired, an example of which is discussed in more detail below.

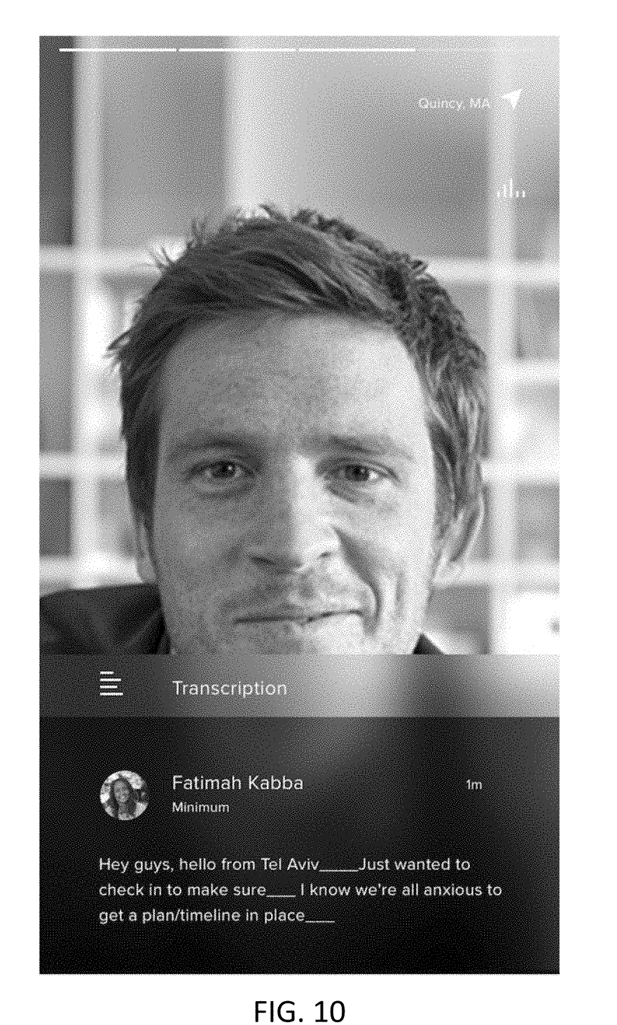

FIG. 10 illustrates a portion of a user interface in which a transcription of the audio of a video message is displayed. The entire transcription may be displayed. Alternatively, as described above, some embodiments of the messaging platform perform content enrichments such as keyword/entity extraction, and one or more of the keywords/entities extracted from the content may be displayed in lieu of the entire transcription. The keywords/entities or transcription may be displayed “in-app” as illustrated in FIG. 10.

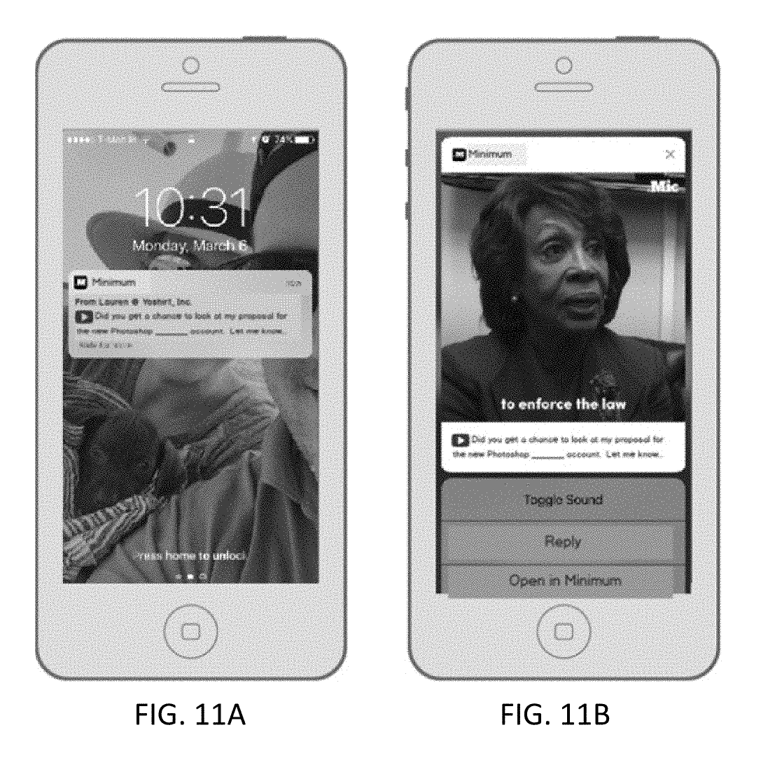

Additionally or alternatively, the keywords/entities or transcription may be displayed as a portion of the push notification transmitted to the recipient device from the platform to provide the receiving user with more information about the message to help the user prioritize viewing and responding to the message. FIG. 11A shows a portion of a user interface in which a push notification transmitted to a message recipient's electronic device includes at least a partial transcription of message generated by a messaging platform in accordance with some embodiments. Providing a partial transcription of the message enables a recipient user to assess a priority for viewing and/or responding to the message. In some embodiments, the user interface may be configured to enable the user to interact with the push notification to perform a function related to the message. For example, as shown in FIG. 11B, the user may play the message, toggle the sound on the message, reply to the message, or open the message in an app to perform other functions.

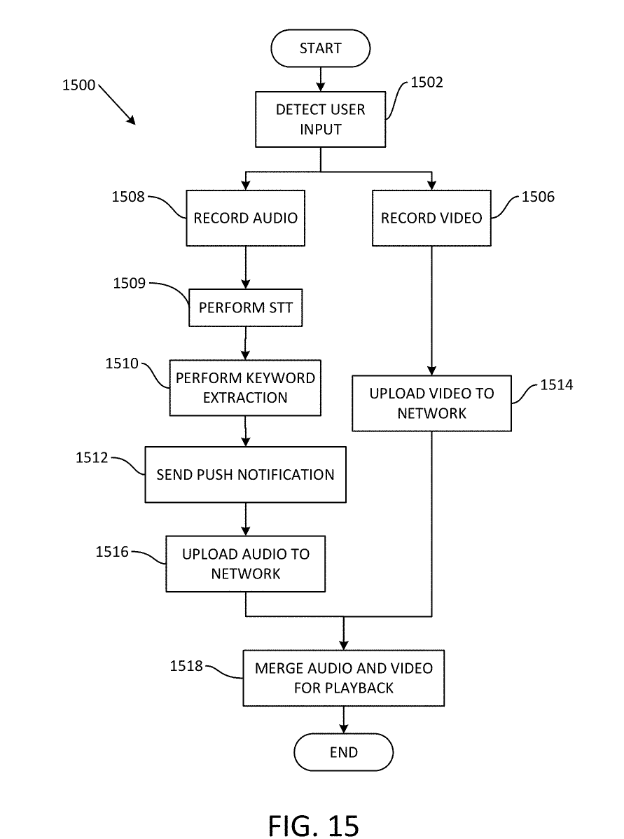

In some embodiments configured to transmit and store recorded video messages on network-connected storage, at least a portion of audio recorded by the user may be processed prior to transferring the video to the network-connected storage. The processed audio may be used, for example, to provide keyword-based push notifications to a user in a manner that is faster than if the audio processing occurred only after the video message was transmitted to the network-connected storage. FIG. 15 illustrates a flow chart of a process 1500 for processing recorded audio during recording of a corresponding video message in accordance with some embodiments. In act 1502, user input is detected. For example, the user may interact with a user interface of an electronic device using a one-touch gesture (e.g., tap and hold) to record a video message. The process then proceeds to act 1506 and 1508, where audio data and video data for a video message are recorded separately and in parallel. For example, each of the audio data and the video data may be recorded and stored as a separate file on the electronic device. Recording audio data separately from the video data enables processing of the audio data to begin prior to transmitting the video data to network (e.g., cloud) storage for further processing.

In accordance with some embodiments, at least some of the audio data recorded in act 1506 is processed during recording of the video message. The audio processing may include, but is not limited to, performing speech to text processing and natural language processing, examples of which include keyword extraction based on transcribed text. The audio processing may be performed locally on the recording device, or at least a portion of the audio processing may be performed using network-based resources. As shown in FIG. 15, the audio processing includes performing speech to text processing in act 1509 and performing keyword extraction processing in act 1510, where the extracted keyword(s) summarize the content of the recorded audio. The process then proceeds to act 1512, where an action is initiated based, at least in part, on a result of the audio processing. In the example process shown in FIG. 15, the action performed in act 1512 may be to provide a push notification to the recipient of the video message that includes one or more of the keywords determined in act 1510. At least some of the keywords may additionally or alternatively be provided to the sender and/or the recipient of the video message using a technique other than a push notification message. For example, one or more of the keywords may be provided in an on-screen notification or an additional action may be performed (e.g., launching an application) based on determining the keyword(s). Processing recorded audio separately from video enables the video message recipient to quickly learn about the content of a sender's video message before the video message is ready for replay, which may be particular helpful when two users are engaged in back-and-forth or “volleying” messaging.

After the user finishes recording the video message, the process proceeds to act 1514, where the video data is uploaded to the network-connected storage. In act 1516, the audio data is also uploaded to the network-attached storage, after which the process proceeds to act 1518, where the audio and video data are merged to make the video message available for playback upon request from the message recipient. The audio data and video data may be merged in any suitable way. For example, each of the audio data and the video data may be associated with an identifier corresponding to the video message and the audio and video data may be merged in response to determining that they have the same video message identifier. The audio data, the video data, or the merged audio and video data may be further processed using one or more of the techniques described herein.

Another advantage of processing at least a portion of the audio while the video message is still being recorded is that less processing will have to be performed upon completion of the video message. For example, if the audio processing in act 1510 involves transcription of the audio, most of the audio may already be transcribed prior to the audio data being uploaded to the network, with only a small amount of processing required following the upload, which provides additional processing speed gains.

As discussed briefly above, a recipient of a message processed using the messaging platform described herein may be another user or an application configured to post or display the message or information based on the message. To enable messages processed by the messaging platform to be transmitted to an app, the data sent to the app should be in a proper format that the app can recognize. Some apps include application programming interfaces (APIs) that enable software developers to place data in a proper format for consumption by the app. Some embodiments are directed to integrating a messaging platform with an app to enable a one-touch interface for providing data to the app rather than having to provide information to the app using a keyboard interface.

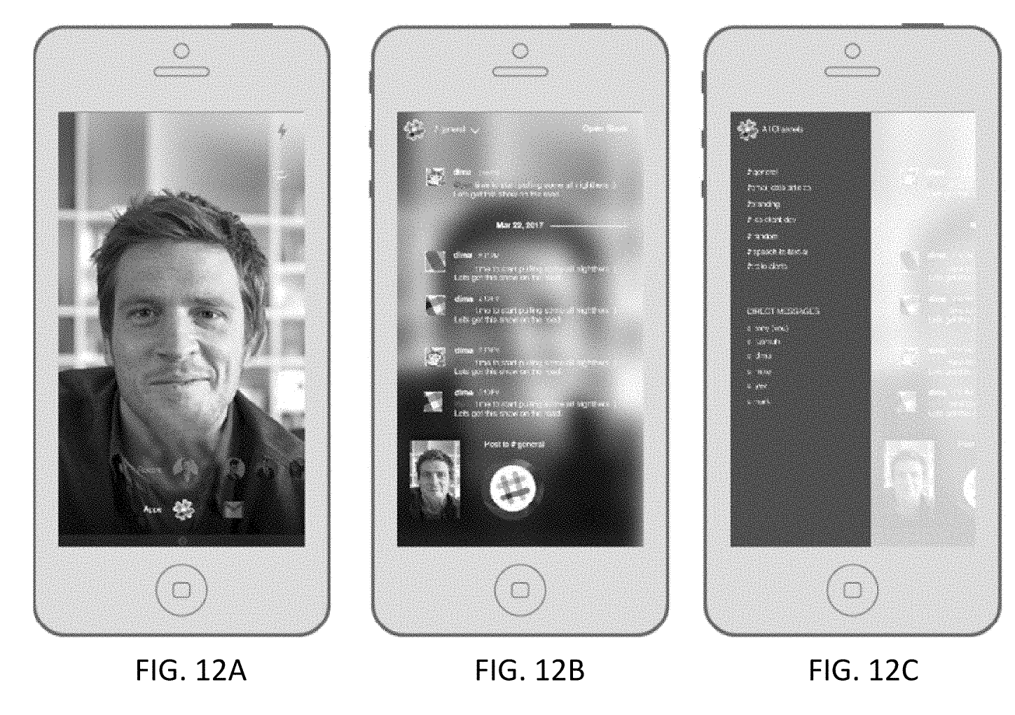

FIGS. 12A-12C illustrate portions of a user interface for sending a message to an app in accordance with some embodiments. FIG. 12A shows a recipient selection portion of the user interface in which a user can select one of a plurality of apps as the recipient of a message. In the example shown in FIGS. 12A-12C, the selected app is Slack, which is an example of a collaboration app commonly used by business professionals. However, it should be appreciated that platform integration with any of a number of productivity apps is contemplated and within the scope of this disclosure. FIG. 12B shows that the user has selected Slack as the app to receive a message, and the user interface displays a particular Slack channel to which the user desires to post a message. The user may interact with the user interface using a one-touch gesture (e.g., tap and hold) to record a video message, shown in the lower left corner of the user interface. Upon completion of the one-touch gesture, the video message is sent to the messaging platform where it is processed by the messaging engine into the particular format (e.g., text) required by the Slack app. After reformatting the message into the proper format (e.g., using APIs provided by the Slack app), the Slack channel is updated with the new message sent from the messaging platform. Accordingly, some embodiments provide a one-touch messaging interface for existing third-party apps to improve the efficiency of interacting with such apps on devices that do not include a keyboard. FIG. 12C shows that in addition to adding the new message to a particular Slack channel, other aspects of the app may also be updated to reflect the addition of the new message. For example, the user interface may be updated with an indication of a new direct message corresponding to the video message transmitted via the messaging platform.

As discussed above, many business professionals prefer asynchronous communication tools, such as email, to communicate with co-workers, clients, and other business partners due to the flexibility of being able to respond to messages when convenient. There are instances however, when multiple parties engaged in asynchronous communication would find it useful to initiate a synchronous communication session. Typically, to initiate a synchronous communication session, a user decides to take the initiative and launch a synchronous communication session using a different platform. Some embodiments are directed to a technique for detecting that multiple users are actively participating in asynchronous communication using the platform and providing an option for the users to seamlessly initiate a synchronous communication session initiated via the platform.

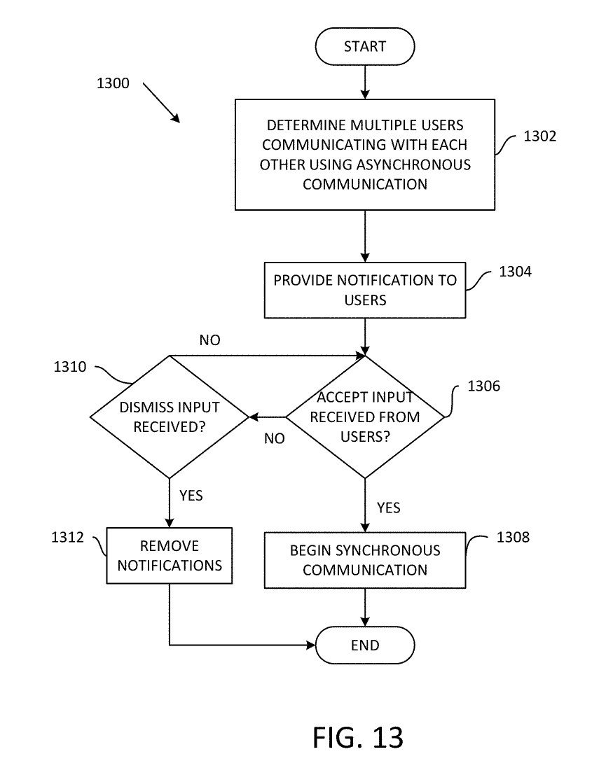

FIG. 13 illustrates a process 1300 for transitioning an asynchronous communication session into a synchronous communication session on the same platform in accordance with some embodiments. In act 1302, it is determined that multiple users are simultaneously or near simultaneously interacting with a messaging platform to communicate asynchronously with each other. For example, the messaging platform may be configured to monitor the messaging activity of users on the platform and may determine that two users are sending messages to each other at the same time or within a short period of time between messages.

When it is determined that two (or more) users are communicating with each other using the messaging platform, the process proceeds to act 1304, where a notification is provided from the messaging platform to the user's electronic devices. The notification may provide the users the option to initiate a synchronous communication session. Any suitable criterion or criteria may be used to determine when to send a notification, and embodiments are not limited in this respect. For example, the messaging platform may determine that a notification should be sent to the users after a number of message “volleys” or “back and fourths” greater than a threshold value have been exchanged between the users during a predetermined time period. The notification provided to the users' devices may be a push notification or another type of notification button or user interface element displayed on users' devices to enable the users to initiate a synchronous communication session upon selection.

Upon receiving the notification, each of the users may interact with the notification element displayed on the screen of their device to either initiate a synchronous communication session or to dismiss the request. Continuing with the process 1300, in act 1306, the messaging platform determines whether one or multiple of the users having received a notification has accepted the request to initiate a synchronous communication session. If it is determined in act 1306 that at least two users to which notifications were provided accept the request, the process proceeds to act 1308 where a synchronous communication session is initiated. Initiating a synchronous communication session includes, but is not limited to, initiating a phone call and starting a live video chatting application session between the users.

If it is determined in act 1306 that a user has not accepted the request to initiate a synchronous communication session, the process proceeds to act 1310 where it is determined whether any of the users has dismissed the request. If it is determined that none of the users has dismissed the request, the process returns to act 1306 where user inputs to the request in the notification continue to be monitored for an acceptance or dismissal of the request. If it is determined in act 1310 that a user has dismissed the request, it is determined that one or both of the users do not want to initiate a synchronous communication session and the process proceeds to act 1012 where the notifications displayed on the users' devices are removed. In some embodiments, both users must accept the request to initiate a synchronous communication session prior to the session being initiated. In some embodiments, when one of the users accepts the request to initiate a synchronous communication the notification provided to the other user(s) is updated to inform the other user(s) that another user has requested initiation of a synchronous communication session.

In some embodiments, the messaging platform may be configured to record, store, and/or transcribe the audio and/or video during a synchronous communication session initiated via the messaging platform. The recorded audio and/or video for the synchronous communication session may be archived and made available for playback by any of the participants in the communication session and/or other users invited to the synchronous communication session but who did not accept the request to participate. For example, if three users engaged in asynchronous communication are invited to participate in a synchronous communication session, but only two of the users accept the request to participate, the third user may be granted access to playback the recorded synchronous communication session in which they were invited, but did not participate.

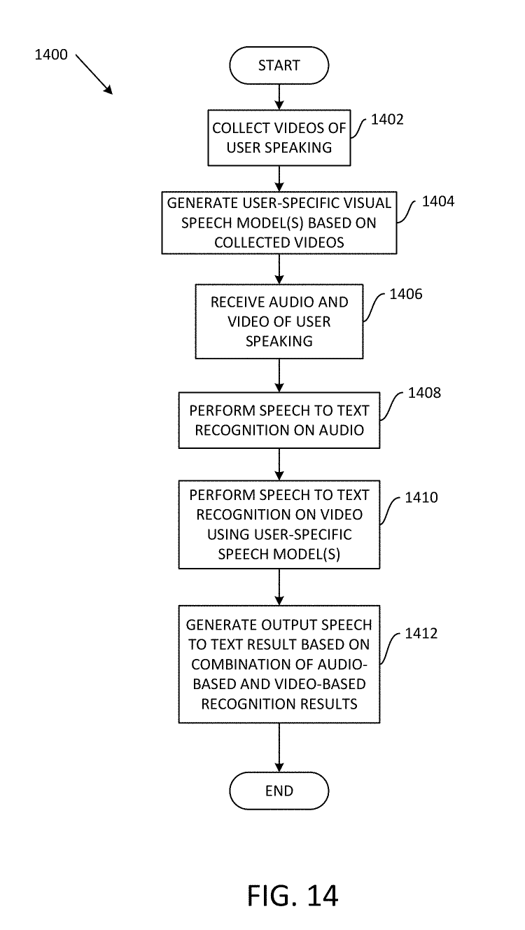

The inventor has recognized that video messages recorded in accordance with some embodiments may provide a personalized dataset of visual speech information of “face videos” that may be used to improve a speech to text transcription process for individual users of the messaging platform. FIG. 14 illustrates a process 1400 for using a dataset of visual speech information for a user to enhance a speech to text transcription process in accordance with some embodiments. In act 1402, video messages of a user speaking are recorded and stored in one or more data stores associated with a messaging platform. The process then proceeds to act 1404 where one or more user-specific visual speech models are generated based on the information in the stored video messages. For example, computer vision techniques may be used to extract facial features of the user during speech that may be used to generate a user-specific model for speech to text transcription. The one or more visual speech models may be stored by the messaging platform and may be used to perform speech to text transcriptions for the user upon receiving additional video messages. Additionally, the visual speech model(s) stored by the platform may be periodically or continuously updated based on visual speech information associated with new video messages sent from the user via the platform.

Process 1400 continues in act 1406, where a video message of the user including audio and video is received. The process proceeds to act 1408, where the received audio data is processed using speech to text processing to generate a text-based result having a first confidence value. Any suitable speech to text processing technique may be used including, but not limited to, a technique for recognition of words and/or phrases. The process then proceeds to act 1410, where speech to text recognition is performed on the received video data and/or a combination of the video data and the audio data using, at least in part, the user-specific visual speech model(s) generated in act 1404. The text output from the process represented in act 1410 may be associated with a second confidence value. The process then proceeds to act 1412, where an output text result is generated based on a combination of the audio-only based speech to text transcription and the video-based speech to text transcription. Portions of the transcription results may be combined based, at least in part, on the confidence scores associated with words and/or phrases in the textual datasets output from each of the processes in acts 1408 and 1410.

The inventor has recognized and appreciated that understanding conversation flow and content for a sequence of video messages in an asynchronous format is often difficult without playing back multiple video messages in the conversation. Accordingly, some embodiments are directed to techniques for providing time-based information about a sequence of video messages in a conversation to help users understand information about the content of the messages.

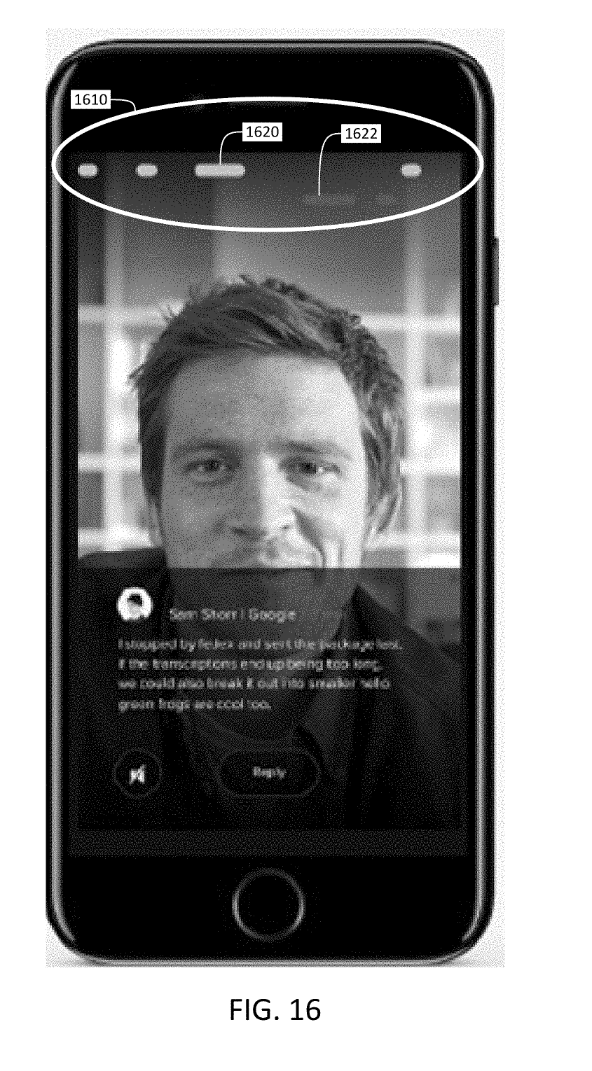

FIG. 16 illustrates a portion of a user interface that displays time-based information for a sequence of video messages in accordance with some embodiments. As shown, the time-based information 1610 is displayed as a series of horizontal “lanes,” each of which corresponds to video messages sent by a particular user. In the example shown in FIG. 16, the time-based information 1610 includes an upper lane 1620 illustrating that four video messages were sent by a first user and a lower lane 1622 illustrating that three video messages 1622 were sent by a second user. Each of the video messages in the conversation may be represented by a visual indicator, where the length of the visual indicator represents the length of the video message and at least one other attribute of the indicator identifies the user that sent the message. In the example shown in FIG. 16, both the color of the indicator and the placement of the indicator in a particular lane within the time-based information 1610 indicate an identity of the user that sent the message. The visual indicators are displayed in time-sequential order such that it is easier for a user to understand information about the conversation including, but not limited to, which participant was most active in the conversation, the relative timing of the video messages in the conversation, the time of day associated with each video message in the conversation, an amount of time elapsed between video messages in the conversation, and whether a particular participant in the conversation provided lots of input on a particular topic, for example, by sending multiple back-to-back video messages.

Although the example shown in FIG. 16 displays a conversation between two participants, it should be appreciated that the time-based information displayed in accordance with some embodiments may represent a series of asynchronous video messages between any number of participants. In some embodiments, the time-based information may represent all conversations between the user of the electronic device on which the time-based information is displayed and all other users with which the user has communicated via the messaging platform during that time.

In some embodiments, video messages and/or information about the video messages for conversations conducted between participants using the messaging platform may be stored locally on the electronic device. For example, video messages for all conversations from the last 24 hours may be cached locally on the device. A user may interact with the time-based information 1610 to scroll (e.g., with a finger swipe) back or forward in time within the time period during which the video messages are cached to view time-based information for video messages in the conversation(s) during that time period. In some embodiments, the user may select a particular date (e.g., from a calendar application) and time-based information 1610 indicating conversations involving the user may be displayed for the selected date.

In some embodiments, one or more of the visual indicators displayed in time-based information 610 may be interactive such that when a user selects the visual indicator (e.g., by tapping on the visual indicator), the video message associated with the visual indicator and/or information derived from the video message (e.g., a transcription, keywords) may be provided to the user. For example, the user may have received a sequence of video messages about a particular topic, and the user may have forgotten what the user asked the sender in response. To determine this information, the user may tap on a received video message and a keyword describing the content of the message may be displayed. The user may then tap on a video message they sent in response to either playback the video message that was sent and/or to receive information derived from the video message (e.g., a transcription of what was said). Providing interactive time-based information about video message conversations in accordance with some embodiments enables users to quickly review what the conversation was about without having to replay each video message in sequence.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, equivalents thereto, inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1. A computer system configured to provide asynchronous messaging, the computer system comprising:
one or more network-connected computer processors programmed to implement a messaging platform, wherein the messaging platform is configured to:
receive input message data from a first electronic device;
process, using a multi-format generation engine, the input message data to generate reformatted data in one or more alternative formats;
store the input message data and the reformatted data in one or more datastores;
receive a request from a second electronic device for message information related to the input message data;
select a format to provide the message information to the second electronic device;
access, based on the selected format, the message information as the stored input message data or the stored reformatted data; and
asynchronously provide the message information to the second electronic device.

2. The computer system of claim 1, wherein the messaging platform is further configured to:
send a notification to the second electronic device, wherein the notification indicates that the message information is available on the messaging platform, and wherein receiving a request from the second electronic device for the message information comprises receiving the request in response to sending the notification.

3. The computer system of claim 2, wherein the messaging platform is further configured to:
generate, based on the stored input message data and/or the stored reformatted data, content for the notification, wherein the content for the notification includes one or more of keyword information summary information sender information, and emotion information associated with content of the input message data.

4. The computer system of claim 3, wherein generating content for the notification comprises including at least a partial transcription of the input message data in the notification.

5. The computer system of claim 2, wherein the messaging platform is further configured to:
enrich the notification by changing a format of the notification to signify a priority of message information.

6. The computer system of claim 5, wherein enriching the notification comprises one or more of changing a color of the notification, changing a size of the notification, and selecting a particular placement of the notification on a display of the second electronic device.

7. The computer system of claim 1, wherein the input message data comprises video data and wherein generating reformatted data comprises extracting audio data from the video data.

8. The computer system of claim 7, wherein generating reformatted data comprises performing speech recognition on the extracted audio data to generate text data.

9. The computer system of claim 1, wherein the messaging platform is further configured to enrich the input message data and/or the reformatted data, wherein enriching the input message data and/or the reformatted data comprises performing one or more of natural language processing, keyword extraction, emotion detection, behavior analytics, associating metadata relating to the first electronic device with the input message data and/or the reformatted data, and associating a user-selectable event with the input message data and/or the reformatted data.

10. The computer system of claim 9, wherein associating metadata relating to the first electronic device with the input message data and/or the reformatted data comprises associating location information, time information, motion information, distance information, weather information, or venue information relating to the first electronic device with the input message data and/or the reformatted data.

11. The computer system of claim 9, wherein the user-selectable event is a hyperlink or a user interface element.

12. The computer system of claim 1, wherein the request from the second electronic device includes information about a current operation of the second electronic device, and wherein selecting a format of the message information comprises selecting a format based on the information about a current operation of the second electronic device included in the request.

13. The computer system of claim 12, wherein the information about a current operation of the second electronic device indicates that the second electronic device is in a non-audio mode, and wherein selecting a format of the message information comprises selecting a text-based format for the message information.

14. The computer system of claim 1, wherein processing the input message data to generate reformatted data in one or more alternative formats comprises generating reformatted data based on a format of a collaboration app.

15. A computer-implemented method of providing asynchronous messaging between electronic devices, the method comprising:
receiving input message data from a first electronic device;
processing, by at least one computer processor, the input message data to generate reformatted data in one or more alternative formats;
storing the input message data and the reformatted data in one or more datastores;
receiving a request from a second electronic device for message information related to the input message data;
selecting a format to provide the message information to the second electronic device;
accessing, based on the selected format, the message information as the stored input message data or the stored reformatted data; and
asynchronously providing the message information to the second electronic device.

16. The computer-implemented method of claim 15, further comprising:
sending a notification to the second electronic device, wherein the notification indicates that the message information is available on the messaging platform, and wherein receiving a request from the second electronic device for the message information comprises receiving the request in response to sending the notification.

17. The computer-implemented method of claim 16, further comprising:
generating, based on the stored input message data and/or the stored reformatted data, content for the notification, wherein the content for the notification includes one or more of keyword information summary information sender information, and emotion information associated with content of the input message data.

18. The computer-implemented method of claim 15, wherein the request from the second electronic device includes information about a current operation of the second electronic device, and wherein selecting a format of the message information comprises selecting a format based on the information about a current operation of the second electronic device included in the request.

19. A non-transitory computer readable medium encoded with a plurality of instructions that, when executed by at least one computer processor, performs a method, the method comprising:
receiving input message data from a first electronic device;
processing the input message data to generate reformatted data in one or more alternative formats;
storing the input message data and the reformatted data in one or more datastores;
receiving a request from a second electronic device for message information related to the input message data;
selecting a format to provide the message information to the second electronic device;
accessing, based on the selected format, the message information as the stored input message data or the stored reformatted data; and
asynchronously providing the message information to the second electronic device.

20. The non-transitory computer readable medium of claim 19, wherein the method further comprises sending a notification to the second electronic device, wherein the notification indicates that the message information is available on the messaging platform, and wherein receiving a request from the second electronic device for the message information comprises receiving the request in response to sending the notification.
